(19) United States
(12) Patent Application Publication
(10) Pub. No.: US 2007/0097985 A1
(43) Pub. Date: May 3, 2007

(54) Method of improving wireless communication QoS by means of automatic packet sizing and forward error correcting based on the dynamic error rate forecast

(76) Inventor: Hyun Lee, Ladera Ranch, CA (US)

Correspondence Address: Hyun Lee, 21 Thalia St, Ladera Ranch, CA, 92694, US

(21) Appl. No.: 11/585,591

(22) Filed: Oct. 24, 2006

Related U.S. Application Data
(60) Provisional application No. 60/732,790, filed on Nov. 2, 2005.

(51) Int. Cl. H04L 12/56

(52) U.S. Cl. 370/395.21; 370/352

(57) ABSTRACT

A method to meet the adequate QoS of wireless network by automatically sizing the packet length and/or by adding appropriate FEC (Forward Error Correction) based on the error rate forecast that is derived from the past behavior of the wireless communication channel.

### RELATED APPLICATIONS

The present application is a continuation application of U.S. provisional patent application, Ser. No. 60/732,790, filed Nov. 2, 2006, for METHOD OF IMPROVING WIRELESS COMMUNICATION QOS BY MEANS OF AUTOMATIC PACKET SIZING AND FORWARD ERROR CORRECTING BASED ON THE DYNAMIC ERROR RATE FORECAST, by Hyun Lee, included by reference herein and for which benefit of the priority date is hereby claimed.

### FIELD OF THE INVENTION

The present invention generally relates to the fields of communication and, more particularly, to Wireless Home Area Networks or Wireless Personal Area Networks that are based on various standard communication protocols.

### BACKGROUND OF THE INVENTION

Since the wireless network always faces the unpredictable interference noise issue in addition to the random noise issue, developing a way of providing the adequate level of QoS for the wireless network has been a difficult task. Thus, and in many cases, the standard committee that develops the wireless network protocol specification of a certain communication network leaves out this task to the network designers (implementers).

Although the WUSB working group developed a standard wireless communication protocol based on the WiMedia (UWB) protocol, the latest WUSB protocol does not mention the QoS requirements. The difficulty of specifying the QoS requirement is evident with the following example.

FIG. 1 (100) shows how the WiMedia (UWB) packet (101) encapsulates USB packets (103), which are constructed with the existing wired USB protocol. USB packets (103) are first amended with protocol conversion (WiMedia to/from USB) information (105) to produce a WUSB (Wireless USB) packet (102). Then, the WUSB packet is amended with WiMedia packet transfer (Data Link, and PHY layer control) control information (104).

As this example demonstrates, since the WiMedia could contain other wired protocol packets as its payload as well as the WUSB packet, WiMedia working group is not in the position to discuss the QoS of a WiMedia network without knowing the QoS requirement of the encapsulated protocol such as WUSB.

Likewise, the WUSB working group cannot talk about the QoS since it encapsulates the USB packets. The WUSB working group cannot dictate the QoS WiMedia working group that targets to develop a wireless protocol that is capable of interfacing with any communication protocol, such as Bluetooth, 1394, etc. Thus, it is not easy for any one of these working groups to undertake the task of standardizing the QoS requirement of the general wireless network.

However, since the WiMedia working group cannot thoroughly own the QoS issue, the WiMedia (UWB) working group would not be able to present an adequate error correction method that would satisfy the complex nature of WHAN and WPAN, which consists of various equipments that use different communication (wired/wireless) protocols along with their own error detection/correction algorithms. Thus, the WiMedia protocol alone, which addresses the layer 1 and 2 (PHY and Data Link layers) of the OSI model, is incapable of supporting high data rate real time operations, such as HDMI/HDCP, in a noisy environment. The wireless communication QoS issue also requires the layer 3 and layer 4 (Network and Transport layers) of the OSI model.

Currently, there are two known proposed solutions to meet the QoS demand for the wireless network. They are the packet-prioritization and the packet-size-reduction methods, for example, Wireless Universal Serial Bus Specification (WUSB)—Revision 1.0

The packet-prioritization is the common solution that is generally implemented in any communication networks. This method assigns the relative priority to packet types depending on the importance of the on-time-delivery schedule. For example, the isochronous packets such as video and audio packets would have the higher priority than the asynchronous packets such as print data.

The packet-size-reduction method is to address the increase of the Bit Error Rate (BER), due to excessive noise, in a wireless network. This method allows the wireless protocol to reduce the transfer packet sizes to minimize the probability of having bit errors in the packet. For example, if the Bit Error Rate is 1E-5, there is likelihood that one bit out of every 100K transferred data bits is in error. Thus, if the packet size is greater than 100K bits, the chance is that every packet contains at least one error, and results in 100% Packet Drop Rate (PDR). In this case, the (wireless) communication network may reduce the packet size to 25K bits to reduce the Packet Drop Rate (PDR) to 25%, indicating that only one packet out of four packets likely is a bad packet according to the 1E-5 Bit Error Rate.

Packet-Prioritization Method

The deficiency of the packet-prioritization method is mainly in the assumption that simply delivering the packet sooner would satisfy the QoS requirement.

However, this method alone cannot battle the noisy wireless network.

In general, since a network cannot utilize packets with error(s), delivering packets sooner would not be enough to address the QoS issue unless there is a way of ensuring that the delivered packets are error free packets. The ability to deliver error free packets is a critical issue in the wireless network where the error rate can fluctuate widely due to interference noise from other wireless networks, and the packet-prioritization method does not address this issue.

Packet-Size-Reduction Method

The packet-size-reduction method allows the wireless network to dynamically reduce the packet size when the error rate in the network increases. However, this method is not capable of dynamically increasing the packet size when the error rate in the network decreases. Since each packet contains a fixed size of the packet overhead that consists of the packet header and the error checking redundancy, a larger packet would contain the bigger ratio of the payload (data) over the packet size. Thus, the larger packet may result in the higher data transfer rate.

Therefore, the lack of ability to increase the packet size is a notable deficiency of the packet-size-reduction method.

It is therefore an object of the invention to present the method of developing the QoS enhancing procedure based on the error rate forecast.

It is another object of the invention to present a methodical way of making dynamic error rate forecasts based on the previous events and the current QoS improving method in use.

### SUMMARY OF THE INVENTION

In accordance with the present invention, there is provided a method to meet the adequate QoS of wireless network by automatically sizing the packet length and/or by adding appropriate FEC (Forward Error Correction) based on the error rate forecast that is derived from the past behavior of the wireless communication channel.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a multiple usb packets in a wimedia (uwb) packet; and

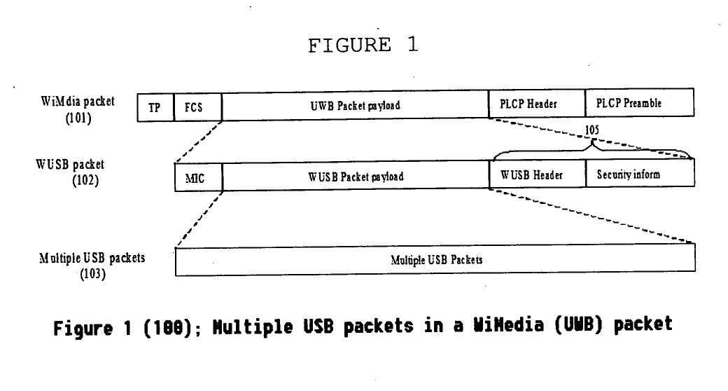

FIG. 2 is a detail view of an example of a methodical way of making dynamic error rate forecasts, and selecting the right qos improving procedure.

For purposes of clarity and brevity, like elements and components will bear the same designations and numbering throughout the Figures.

### DESCRIPTION OF THE PREFERRED EMBODIMENT

This invention comprises of two sections. The first section presents a list of methods to improve the QoS of wireless communication. The second section presents a methodical way of making dynamic error rate forecasts based on the previous events to determine which QoS improving method to use, and under what circumstances.

The key of this method is how to integrate the role of the base 4 layer of the OSI model, i.e. PHY, Data Link, Network, and Transport layers.

The methods in the first section are examples of error correction algorithms and packet size selecting methods. The methods presented in this application are not a complete list of various methods. Anyone who is trained in this art can achieve the same or better result using other type methods, such as turbo code. Therefore, this application teaches the need of using error recovering or reduction methods to improve the QoS of the wireless communication that is based on the UWB (WiMedia). This application does not dictate whether to use a particular error recovering or reduction method.

The methodical way of selecting an appropriate QoS improving method, which is presented in the second section, is a way of making a decision on which QoS improving method to use, and under what circumstance. A person trained in this field can devise a different method of choosing different QoS improving methods based on this example. Therefore, this application teaches, with an example, the need to make dynamic error rate forecasts based on the previous events to choose an appropriate QoS improving method, and the execution process of the QoS improving method could be implemented in the firmware and/or the software as well as in the MAC hardware for the just-in-time operation.

This application presents an example to demonstrate a novel method to improve the QoS of wireless communication. The WiMedia protocol is chosen for this example.

List of methods to improve the QoS of wireless communication:

Error Correction:

The way of improving the QoS of wireless communication under a given bit rate is dependent on the error type, the error rate, and time of error occurrences.

The error types are random single bit errors, burst errors, and erasure-errors.

The erasure-error is the type of error that occurs when a receiver receives a signal with an undefined logical level instead of a wrong logic level. For the Data Link layer to be able to handle this type of error effectively, the PHY layer has to provide the information stating which bit was received with the undefined logic level. This type of error can be easily corrected with an erasure-error correcting algorithm. However, the WiMedia PHY is not capable of reporting these types of errors.

The burst errors are produced mainly due to signal interferences. Thus, an interleaving Read-Solomon Code is the best method to correct these types of errors.

The random single bit errors are due to random noise. These types of errors can be handled either with a simple BCH code or Viterbi code, depending on the packet length.

Packet Length Modulation:

The packet size determination is also based on the error rate. For example, if the error rate is 1×10e-5, and all transfer packet sizes are 4 Kbytes, then, in average, every 3rd packet contains at least one error. This causes the effective data transfer rate to decrease by ⅓. Therefore, in this case, it is better to transfer smaller packets. However, the decision process of choosing the optimum packet size for a certain error rate also has to include the packet overhead cost. For example, WiMedia requires the minimum of 6.3 μsec to 10 μsec overhead to send a USB packet. Since this overhead translates to 3K to 4K bit time, making the packet size less than 512 bytes actually reduces the overall data rate by more than ½ of full data bandwidth, which results in more than 30% slower overall data rate than 4 Kbyte packets with 1×10e-5 error rate.

Determining which QoS Improving Method to Use:

The selection process is mainly based on the current packet size and the previous events. For example, if the packet payload size is 512 bytes, and the FCS mismatch occurs every 10th packet, then the reasonable assumption would be that the error rate is 1.25×10e-5, since the receiver sees 1 error per ten 1 k-byte duration of bit time. In this case it is better to implement a simple BCH error correcting code with a minimum distance of 3 (t>3), which can correct a single bit error. This code may increase the packet length by a few bytes, but it improves the overall data transfer rate by 11%.

Deciding which Code to Pick—Block Code, Viterbi Code, or Turbo Code:

This decision is should be base on two criteria, the desired data rate and the previous error rate.

The code rate of block code is defined by kb/n, where kb is the message length and n is code length. This block code has (n−k) redundant bits (or symbols) for error handling purpose. The data transfer efficiency of a block code also is kb/n.

The code rate of a Viterbi code is also defined by kv/n with the same n and kv definitions. However, the data transfer efficiency of a Viterbi code is defined as kv L/n(L+m), where L is number of messages and m is the maximum number of registers in the convolution code generating shift register.

Therefore, the code that gives better data transfer efficiency can be decided as
kb/n>kvL/n(L+m),

If this is ture, then a block code is chosen. Otherwise a Viterbi code is chosen.

Here kb and kv are not the same since, unlike a block code, the error correcting capability of a Viterbi code is not measured by (n−kv) redundant bits. However, the decision of selecting the values of n, kb, and kv is still based on the previous history of the error rate.

Example of QoS Improving Procedure:

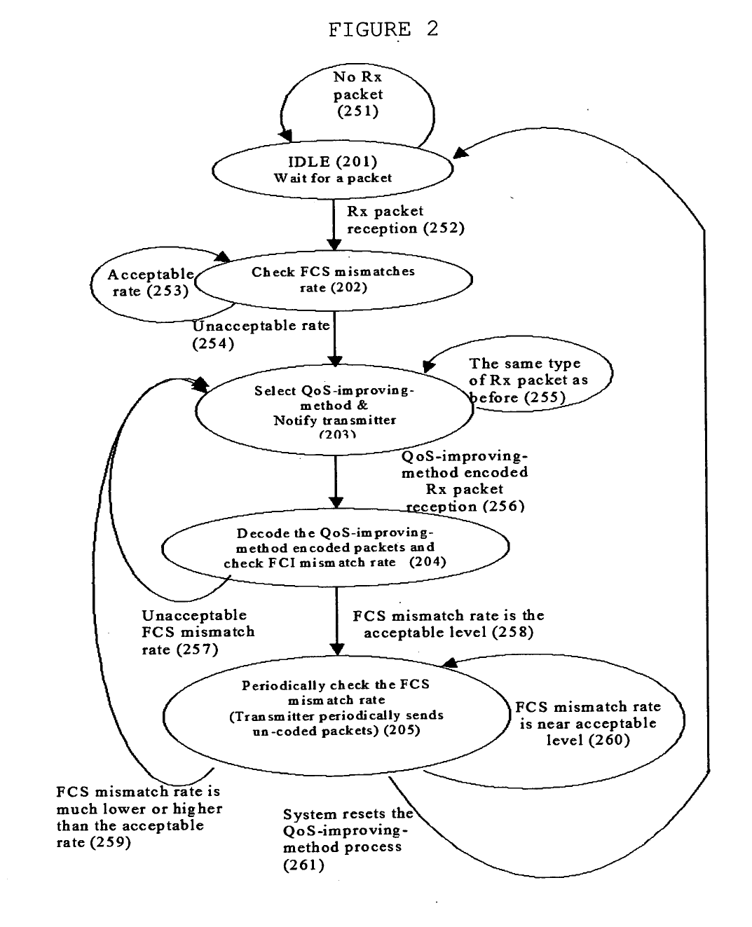

FIG. 2 (200) shows an example of a methodical way of making dynamic error rate forecasts, and selecting the right QoS improving procedure.

When a wireless transfer starts (252), the receiving MAC starts to accumulate two events: the average received packet size and the number of FCS errors.

If the FCS mismatch rate (202) is acceptable (253) for the given application, no action is taken. The acceptable FCS mismatch rate is based on the error free packet transfer rate for a given application. If the FCS mismatch rate is unacceptably high (254), the receiver decides on the optimum QoS improving method (203) that can reduce the error rate at the same time to support the desired data rate to support the application. Once the receiver makes the decision on a QoS improving method, it notifies the transmitter using the Application-specific command frame (203). The transmitter encodes the QoS-improving-method into the transmitting data according to the receiver's request. The transmitter also indicates that the packet is a QoS-improving-method-encoded packet by setting the appropriate bit in the Application-specific command frame.

After the first QoS-improving-method encoded packet is received (256), the receiver resets the average received packet size and the number of FCS errors. Whether the transmitter sends a QoS-improving-method-encoded packet or not, the FCS value is computed with the original data. Thus, the receiver needs to check the FCS after error correction is done if the QoS-improving-method is an error-correcting-code. The receiver checks the FCS on received packet as is, if the QoS-improving-method is a packet size reduction method.

The receiver repeats this process until the FCS mismatch rate is acceptable for the given application (257).

In general, since the receiver should be able to choose the right QoS-improving-method based on the prior events (the average error rate for the average packet size), the receiver only needs to execute the QoS-improving-method selecting process once or twice.

If the FCS mismatch rate is much better than the acceptable FCS mismatch rate (259), the receiver may send a request to the transmitter to transfer un-encoded packets or enlarge the packet sizes to improve the data rate. If the FCS mismatch rate goes up at this time, the receiver selects an alternative QoS-improving-method to reduce the error rate (259, 203). The transmitter periodically transmits regular packets to check the level of the wireless channel error injection rate (205). If the receiver determines the error rate is blow the acceptable rate 253, the receiver requests the transmitter to send un-encoded packets (259).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of improving wireless communication qos by means of automatic packet sizing and forward error correcting based on the dynamic error rate forecast for automatic packet-sizing and forward-error-correction techniques based on the dynamic error rate forecast for meeting the qos requirement of a wireless network that needs to support a multiple simulatneous realtime streaming video, comprising:
means for computing the fcs mismatch rate based on the ratio of error packet versus the error free packet that were transfered for a given application;
means for selecting an optimum qos improving method that can reduce the error rate at the same time to support the desired data rate to support the application, and also notifying the transmitters in the network using the application-specific command frame;
means for the receiver checking the fcs after error correction is done if the qos-improving-method is an error-correcting-code, or checking the fcs on received packet as is if the qos-improving-method is a packet size reduction method;
means for the transmitter periodically transmitting regular packets to check the level of the wireless channel error injection rates;
means for indicating that receiving a packet causes the receiving mac to start computing the average packet size and accumulating the number of fcs errors;
means for indicating that the qos improving process does not take any action if the fcs mismatch rate is acceptable for the given application;
means for indicating that the qos improving process starts if the fcs mismatch rate is unacceptably high;
means for indicating that the transmitter has encoded the qos-improving-method as the receiver has requested, and informing the receiver by setting the appropriate bit in the application-specific command frame;
means for indicating that the receiver needs to repeat the “qos improving method” selection process until the fcs mismatch rate is acceptable for the given application;
means for indicating that the fcs mismatch rate is acceptable for the given application, thus terminating the qos improving method selection process;
means for restarting the qos improving method selection process when the fcs mismatch or ber rate changes drastically during network operation; and
means for indicating that the fcs mismatch rate is near the acceptable rate such that the qos improving process is stabilized.

2. The method of improving wireless communication qos by means of automatic packet sizing and forward error correcting based on the dynamic error rate forecast in accordance with claim 1, wherein said means for computing the fcs mismatch rate based on the ratio of error packet versus the error free packet that were transfered for a given application comprises a state, check-fcs-mismatches.

3. The method of improving wireless communication qos by means of automatic packet sizing and forward error correcting based on the dynamic error rate forecast in accordance with claim 1, wherein said means for selecting an optimum qos improving method that can reduce the error rate at the same time to support the desired data rate to support the application, and also notifying the transmitters in the network using the application-specific command frame comprises a state, select-qos-improving-mehtod-&-notify-transmitter.

4. The method of improving wireless communication qos by means of automatic packet sizing and forward error correcting based on the dynamic error rate forecast in accordance with claim 1, wherein said means for the receiver checking the fcs after error correction is done if the qos-improving-method is an error-correcting-code, or checking the fcs on received packet as is if the qos-improving-method is a packet size reduction method comprises a state, decode-the-qos-improving-method.

5. The method of improving wireless communication qos by means of automatic packet sizing and forward error correcting based on the dynamic error rate forecast in accordance with claim 1, wherein said means for the transmitter periodically transmitting regular packets to check the level of the wireless channel error injection rates comprises a state, periodically check the fcs mismatch rate.

6. The method of improving wireless communication qos by means of automatic packet sizing and forward error correcting based on the dynamic error rate forecast in accordance with claim 1, wherein said means for indicating that receiving a packet causes the receiving mac to start computing the average packet size and accumulating the number of fcs errors comprises an event, rx packet reception.

7. The method of improving wireless communication qos by means of automatic packet sizing and forward error correcting based on the dynamic error rate forecast in accordance with claim 1, wherein said means for indicating that the qos improving process does not take any action if the fcs mismatch rate is acceptable for the given application comprises a decision point, acceptable rate.

8. The method of improving wireless communication qos by means of automatic packet sizing and forward error correcting based on the dynamic error rate forecast in accordance with claim 1, wherein said means for indicating that the qos improving process starts if the fcs mismatch rate is unacceptably high comprises a decision point, unacceptable rate.

9. The method of improving wireless communication qos by means of automatic packet sizing and forward error correcting based on the dynamic error rate forecast in accordance with claim 1, wherein said means for indicating that the transmitter has encoded the qos-improving-method as the receiver has requested, and informing the receiver by setting the appropriate bit in the application-specific command frame comprises a monitoring point, qos improving method encoded rx packet reception.

10. The method of improving wireless communication qos by means of automatic packet sizing and forward error correcting based on the dynamic error rate forecast in accordance with claim 1, wherein said means for indicating that the receiver needs to repeat the “qos improving method” selection process until the fcs mismatch rate is acceptable for the given application comprises a monitoring point, decision point, unacceptable fcs mismatch rate.

11. The method of improving wireless communication qos by means of automatic packet sizing and forward error correcting based on the dynamic error rate forecast in accordance with claim 1, wherein said means for indicating that the fcs mismatch rate is acceptable for the given application, thus terminating the qos improving method selection process comprises a decision point, fcs mismatch rate is the acceptable level.

12. The method of improving wireless communication qos by means of automatic packet sizing and forward error correcting based on the dynamic error rate forecast in accordance with claim 1, wherein said means for restarting the qos improving method selection process when the fcs mismatch or ber rate changes drastically during network operation comprises a decision point, fcs mismatch rate is much higer or lower than the acceptable rate.

13. The method of improving wireless communication qos by means of automatic packet sizing and forward error correcting based on the dynamic error rate forecast in accordance with claim 1, wherein said means for indicating that the fcs mismatch rate is near the acceptable rate such that the qos improving process is stabilized comprises a decision point, fcs mismatch rate is near acceptable level.

14. A method of improving wireless communication qos by means of automatic packet sizing and forward error correcting based on the dynamic error rate forecast for automatic packet-sizing and forward-error-correction techniques based on the dynamic error rate forecast for meeting the qos requirement of a wireless network that needs to support a multiple simulatneous realtime streaming video, comprising:
a state, check-fcs-mismatches, for computing the fcs mismatch rate based on the ratio of error packet versus the error free packet that were transfered for a given application;
a state, select-qos-improving-mehtod-&-notify-transmitter, for selecting an optimum qos improving method that can reduce the error rate at the same time to support the desired data rate to support the application, and also notifying the transmitters in the network using the application-specific command frame;
a state, decode-the-qos-improving-method, for the receiver checking the fcs after error correction is done if the qos-improving-method is an error-correcting-code, or checking the fcs on received packet as is if the qos-improving-method is a packet size reduction method;
a state, periodically check the fcs mismatch rate, for the transmitter periodically transmitting regular packets to check the level of the wireless channel error injection rates;
an event, rx packet reception, for indicating that receiving a packet causes the receiving mac to start computing the average packet size and accumulating the number of fcs errors;
a decision point, acceptable rate, for indicating that the qos improving process does not take any action if the fcs mismatch rate is acceptable for the given application;
a decision point, unacceptable rate, for indicating that the qos improving process starts if the fcs mismatch rate is unacceptably high;
a monitoring point, qos improving method encoded rx packet reception, for indicating that the transmitter has encoded the qos-improving-method as the receiver has requested, and informing the receiver by setting the appropriate bit in the application-specific command frame;
a monitoring point, decision point, unacceptable fcs mismatch rate, for indicating that the receiver needs to repeat the “qos improving method” selection process until the fcs mismatch rate is acceptable for the given application;
a decision point, fcs mismatch rate is the acceptable level, for indicating that the fcs mismatch rate is acceptable for the given application, thus terminating the qos improving method selection process;
a decision point, fcs mismatch rate is much higer or lower than the acceptable rate, for restarting the qos improving method selection process when the fcs mismatch or ber rate changes drastically during network operation; and
a decision point, fcs mismatch rate is near acceptable level, for indicating that the fcs mismatch rate is near the acceptable rate such that the qos improving process is stabilized.

15. The method of improving wireless communication qos by means of automatic packet sizing and forward error correcting based on the dynamic error rate forecast as recited in claim 14, further comprising:
the waiting period until the network adopts the new qos improving method, the same type of rx packets as before, for indicating that the receiver waiting for the transmitters to implement the qos improving procedure.

16. A method of improving wireless communication qos by means of automatic packet sizing and forward error correcting based on the dynamic error rate forecast for automatic packet-sizing and forward-error-correction techniques based on the dynamic error rate forecast for meeting the qos requirement of a wireless network that needs to support a multiple simulatneous realtime streaming video, comprising:
a state, check-fcs-mismatches, for computing the fcs mismatch rate based on the ratio of error packet versus the error free packet that were transfered for a given application;
a state, select-qos-improving-mehtod-&-notify-transmitter, for selecting an optimum qos improving method that can reduce the error rate at the same time to support the desired data rate to support the application, and also notifying the transmitters in the network using the application-specific command frame;
a state, decode-the-qos-improving-method, for the receiver checking the fcs after error correction is done if the qos-improving-method is an error-correcting-code, or checking the fcs on received packet as is if the qos-improving-method is a packet size reduction method;
a state, periodically check the fcs mismatch rate, for the transmitter periodically transmitting regular packets to check the level of the wireless channel error injection rates;
an event, rx packet reception, for indicating that receiving a packet causes the receiving mac to start computing the average packet size and accumulating the number of fcs errors;
a decision point, acceptable rate, for indicating that the qos improving process does not take any action if the fcs mismatch rate is acceptable for the given application;
a decision point, unacceptable rate, for indicating that the qos improving process starts if the fcs mismatch rate is unacceptably high;
the waiting period until the network adopts the new qos improving method, the same type of rx packets as before, for indicating that the receiver waiting for the transmitters to implement the qos improving procedure;
a monitoring point, qos improving method encoded rx packet reception, for indicating that the transmitter has encoded the qos-improving-method as the receiver has requested, and informing the receiver by setting the appropriate bit in the application-specific command frame;
a monitoring point, decision point, unacceptable fcs mismatch rate, for indicating that the receiver needs to repeat the “qos improving method” selection process until the fcs mismatch rate is acceptable for the given application;
a decision point, fcs mismatch rate is the acceptable level, for indicating that the fcs mismatch rate is acceptable for the given application, thus terminating the qos improving method selection process;
a decision point, fcs mismatch rate is much higer or lower than the acceptable rate, for restarting the qos improving method selection process when the fcs mismatch or ber rate changes drastically during network operation; and
a decision point, fcs mismatch rate is near acceptable level, for indicating that the fcs mismatch rate is near the acceptable rate such that the qos improving process is stabilized.
